(19) United States
(12) Patent Application Publication
(10) Pub. No.: US 2025/0060549 A1
(43) Pub. Date: Feb. 20, 2025

(54) COMPACT DISTRIBUTION ENCLOSURE CONFIGURED TO PROVIDE ENHANCED CONNECTIVITY AND ACCESS TO AN INTERIOR OF THE ENCLOSURE

(71) Applicant: PPC BROADBAND, INC., East Syracuse, NY (US)

(72) Inventor: SANDEEP PULIYANKULANGARA, Ernakulam (IN)

(73) Assignee: PPC BROADBAND, INC., East Syracuse, NY (US)

(21) Appl. No.: 18/809,224

(22) Filed: Aug. 19, 2024

(30) Foreign Application Priority Data
Aug. 18, 2023 (IN) 202321055383

(51) Int. Cl. G02B 6/44

(52) U.S. Cl. CPC G02B 6/4446; G02B 6/4429; G02B 6/4444; G02B 6/445; G02B 6/44528; G02B 6/4454

(57) ABSTRACT

A cable distribution enclosure may include a body portion and a tray portion. The tray portion may be structurally configured to permit a user to configure the enclosure with a fiber optic splitter module held by a first side portion and having input and output ports extending through the access portion so as to permit preterminated fiber optic drop cables that extend to an exterior of the enclosure to be coupled with the input outport ports of the fiber optic splitter module without accessing the first side portion of the tray portion, and to alternatively configure the enclosure with an fiber optic pigtail that extends from the first side portion through the access portion to a second splice portion at the second side portion so as to permit a fiber optic drop cable that extends to an interior of the enclosure to be coupled with the fiber optic pigtail at the second splice portion without accessing the first side portion of the tray portion so as to enhance connectivity of the fiber optic enclosure.

### CROSS REFERENCE TO RELATED APPLICATION

This application claims the benefit of Indian Provisional Patent Application No. 202321055383, filed in India on Aug. 18, 2023, the disclosure of which is hereby incorporated by reference herein in its entirety.

### TECHNICAL FIELD

The present disclosure is directed to a distribution box and, more particularly, to fiber optic cable distribution enclosure having a compact physical size and configured to provide enhanced connectivity and access to an interior of the enclosure.

### BACKGROUND

Research and development of signal transmission technologies has advanced many different means for transferring signals and data across relatively long distances. Advancements in fiber optic signal transmission have received steady adoption in residential, commercial, and industrial applications. As a result, more fiber optic cables are being distributed to more sites that correspond with greater numbers of connections and terminal ends.

The use of cable distribution boxes to provide interconnections and terminal ends can provide physical and environmental protection for cable connections that are potentially at risk. However, such distribution boxes can have limited connectivity and laborious access requirements that create inefficiencies during installation and utilization.

For these reasons, it is a continued goal for signal transmission distribution to employ a distribution box that has increased connectivity capabilities and improved access. Accordingly, it may be desirable to provide a compact fiber optic cable distribution enclosure configured to provide enhanced connectivity and access.

### SUMMARY

In accordance with various aspects of the disclosure, a cable distribution enclosure may include a first body portion having a port portion structurally configured to provide a sealed opening configured to receive a fiber optic cable passing through the port portion from an exterior of the first body portion to an interior of the first body portion, a second body portion configured to cooperate with the first body portion to provide a watertight enclosure, a hinge portion structurally configured to connect the second body portion with the first body portion, and a tray portion configured to be disposed in and pivotally coupled with the first body portion. The second body portion may be configured to rotate relative to the first body portion about the hinge portion between a closed position in which the first body portion contacts the second body portion to form a watertight enclosure, and an open position in which the second body portion is rotated away from the first body portion to permit access to the tray portion. The hinge portion may include a biasing portion configured to urge the second body portion relative to the first body portion toward the closed position, and the hinge portion may include a stay portion that is configured to overcome a biasing force applied to the second body portion by the biasing portion to maintain the second body portion in the open position relative to the first body portion when the second body portion is moved away from the first body portion to a defined angular orientation relative to the first body portion so as to permit a user to perform to access the tray portion in the cable distribution box without holding the second portion in the open position. The tray portion may include a first side portion facing the first body portion and a second side portion facing the second body portion, and may include a knockout portion configured to be removed from the tray portion to provide an access portion through the tray portion from the second side portion to the first side portion. The first side portion may include a holding portion configured to hold a fiber optic splitter and a first splice portion configured to retain fiber optic splice connections, the second side portion may include a second splice portion configured to retain fiber optic splice connections between optical fiber pigtails extending through the access portion from the first side portion and an optical fiber drop cable extending through the port portion of the first body portion, and the first body portion may be configured to receive a fiber optic splitter module such that an input port and output ports of the fiber optic splitter module extend through the access portion so as to permit connectors of preterminated fiber optic drop cables to be coupled with the input port and the outport ports. The tray portion may be structurally configured to provide enhanced connectivity by permitting a user to configure the enclosure with a fiber optic splitter module held by the first side portion and having the input port and the output ports extending through the access portion so as to permit preterminated fiber optic drop cables that extend through the port portion to an exterior of the enclosure to be coupled with the input port and the outport ports of the fiber optic splitter module without accessing the first side portion of the tray portion, and to alternatively configure the enclosure with fiber optic pigtails that extend from the first side portion through the access portion to the second splice portion so as to permit fiber optic drop cables that extend through the port portion to an exterior of the enclosure to be coupled with the fiber optic pigtails at the second splice portion without accessing the first side portion of the tray portion so as to enhance connectivity of the fiber optic enclosure.

In accordance with various aspects of the disclosure, a cable distribution enclosure may include a first body portion having a port portion structurally configured to receive a fiber optic cable passing through the port portion from an exterior of the first body portion to an interior of the first body portion, a second body portion hingedly coupled with the first body portion, and a tray portion configured to be disposed in and pivotally coupled with the first body portion. The second body portion may be configured to rotate relative to the first body portion between a closed position to form an enclosure and an open position in which the second body portion is rotated away from the first body portion to permit access to the tray portion. The tray portion may include a first side portion facing the first body portion and a second side portion facing the second body portion, and the tray portion may include a knockout portion configured to be removed from the tray portion to provide an access portion through the tray portion from the second side portion to the first side portion. The first side portion may include a holding portion configured to hold a fiber optic splitter and a first splice portion configured to retain fiber optic splice connections, the second side portion may include a second splice portion configured to retain fiber optic splice connections between optical fiber pigtails extending through the access portion from the first side portion and an optical fiber drop cable extending through the port portion of the first body portion, and the first body portion may be configured to receive a fiber optic splitter module such that an input port and output ports of the fiber optic splitter module extend through the access portion so as to permit connectors of preterminated fiber optic drop cables to be coupled with the input port and the outport ports. The tray portion may be structurally configured to provide enhanced connectivity by permitting a user to configure the enclosure with a fiber optic splitter module held by the first side portion and having the input port and the output ports extending through the access portion so as to permit preterminated fiber optic drop cables that extend through the port portion to an exterior of the enclosure to be coupled with the input port and the outport ports of the fiber optic splitter module without accessing the first side portion of the tray portion, and to alternatively configure the enclosure with fiber optic pigtails that extend from the first side portion through the access portion to the second splice portion so as to permit fiber optic drop cables that extend through the port portion to an exterior of the enclosure to be coupled with the fiber optic pigtails at the second splice portion without accessing the first side portion of the tray portion so as to enhance connectivity of the fiber optic enclosure.

In accordance with various aspects of the disclosure, a cable distribution enclosure may include a body portion structurally configured to receive a fiber optic cable from an exterior of the body portion to an interior of the body portion and a tray portion configured to be disposed in the body portion. The tray portion may include a first side portion facing the body portion and a second side portion facing away from the body portion and may be configured to provide an access portion through the tray portion from the second side portion to the first side portion. The first side portion may include a holding portion configured to hold a fiber optic splitter and a first splice portion configured to retain a fiber optic splice connections, the second side portion may include a second splice portion configured to retain fiber optic splice connections between an optical fiber pigtail extending through the access portion from the first side portion and an optical fiber drop cable extending through the port portion of the first body portion, and the first body portion may be configured to receive a fiber optic splitter module such that an input port and an output port of the fiber optic splitter module extend through the access portion so as to permit connectors of preterminated fiber optic drop cables to be coupled with the input port and the outport port. The tray portion may be structurally configured to provide enhanced connectivity by permitting a user to configure the enclosure with a fiber optic splitter module held by the first side portion and having the input port and the output port extending through the access portion so as to permit preterminated fiber optic drop cables that extend through the port portion to an exterior of the enclosure to be coupled with the input port and the outport port of the fiber optic splitter module without accessing the first side portion of the tray portion, and to alternatively configure the enclosure with an fiber optic pigtail that extends from the first side portion through the access portion to the second splice portion so as to permit a fiber optic drop cable that extends through the port portion to an exterior of the enclosure to be coupled with the fiber optic pigtail at the second splice portion without accessing the first side portion of the tray portion so as to enhance connectivity of the fiber optic enclosure.

Various aspects of the system, as well as other embodiments, objects, features, and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a line representation of portions of a cable distribution environment in which assorted embodiments can be practiced.

FIG. 2 is a line representation of portions of an example of a cable distribution assembly that may be employed in the environment of FIG. 1 in various embodiments.

FIGS. 3A-3D respectively convey perspective views of portions of an example of a distribution box that can be employed in the environment of FIG. 1.

FIGS. 4A-4D respectively convey perspective views of portions of an example of a tray portion configured in accordance with various embodiments.

FIG. 5 is a perspective view of portions of an example of a module that can be utilized in the embodiments of FIGS. 3A-4D.

FIG. 6 displays assorted plan views of an example of a compact distribution box configured in accordance with various embodiments.

### DETAILED DESCRIPTION OF EMBODIMENTS

Reference will now be made in detail to exemplary embodiments and methods of the present disclosure. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

In signal transmission distribution, cables are frequently split, diverted, combined, or terminated. Often, such cable management happens on-site, which potentially exposes changes to a cable to environmental and physical stresses that jeopardize the operation and/or performance of one or more cables. The protection of cable interconnections on-site with a cable distribution box has, conventionally, involved a sealed container that provided limited connectivity capabilities and posed physical access inefficiencies. Hence, assorted embodiments are directed to a single cable distribution box with greater connectivity capabilities and efficient physical access.

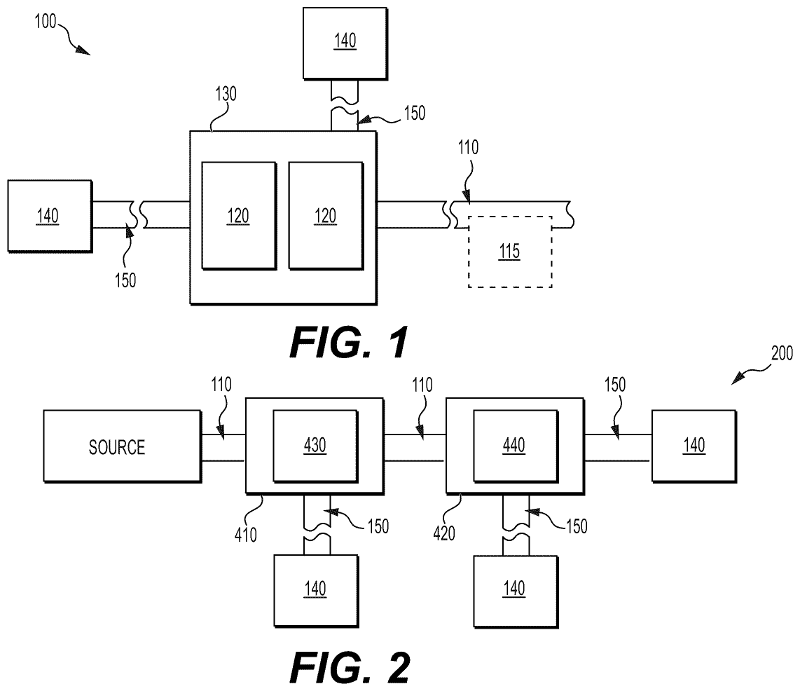

Various embodiments of a distribution box are illustrated in the drawings. FIG. 1 illustrates a line representation of an example of a cable distribution environment 100 in which embodiments of a compact distribution box can be employed. An input cable 110 can originate at a source, such as a transmission hub, amplifier, switch, or computing device. The input cable 110 can comprise any number of signal conductors such as, for example, fiber optic or coaxial hardline conductors. It is contemplated, but not required, that the input cable 110 has multiple integrated signal conductors, such as a 16F cable, which are individually packaged as separate cables where each conductor is surrounded by a separate insulating material.

While the input cable 110 may engage one or more connectors, adapters, or other interconnects 120 in a position exposed to environmental elements, as conveyed by segmented box 115, embodiments can isolate cable connections within a distribution box 130 that provides protection from environmental and physical stresses. The distribution box 130 can be any size, shape, and location relative to a cable terminal 140 while employing any closure mechanism and sealing structure. The use of the distribution box 130 can provide safe and secure establishment and maintenance of signal conductor connections via one or more interconnects 120, such as adapters, splices, cassettes, interfaces, and connectors, to produce one or more output cables 150.

FIG. 2 illustrates a line representation of portions of an example of a cable distribution assembly 200 in which various embodiments may be practiced. The use of a distribution box 130 may provide the physical size and structural capability to divert one or more signal conductors from an input cable 110 in the form of at least one output cable 150. Yet, many embodiments of a distribution box 130 provide relatively limited connectivity in the form of interconnections.

In the non-limiting example shown in FIG. 2, separate distribution boxes 410/420 are employed to provide different splitter 430 or splicing 440 interconnections. While both interconnection 120 types may be provided within a single distribution box, such as box 130 of FIG. 1, such combination can be cumbersome, add complexity, and be practically inefficient compared to the separate distribution boxes 410/420 shown in FIG. 2 with single types of interconnections. The use of multiple distribution boxes 410/420 may simplify cable management, but can add inefficiency as increased physical space is taken up by the separate boxes 410/420. Additionally, the added time associated with physically accessing the separate distribution boxes 410/420 can increase inefficiency over the life of the cables 110/150.

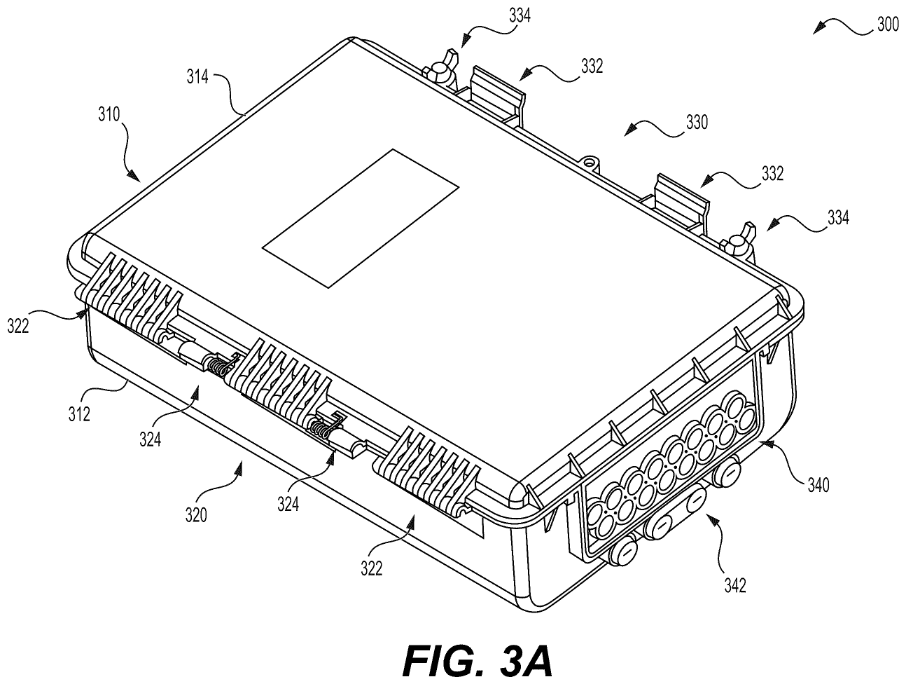

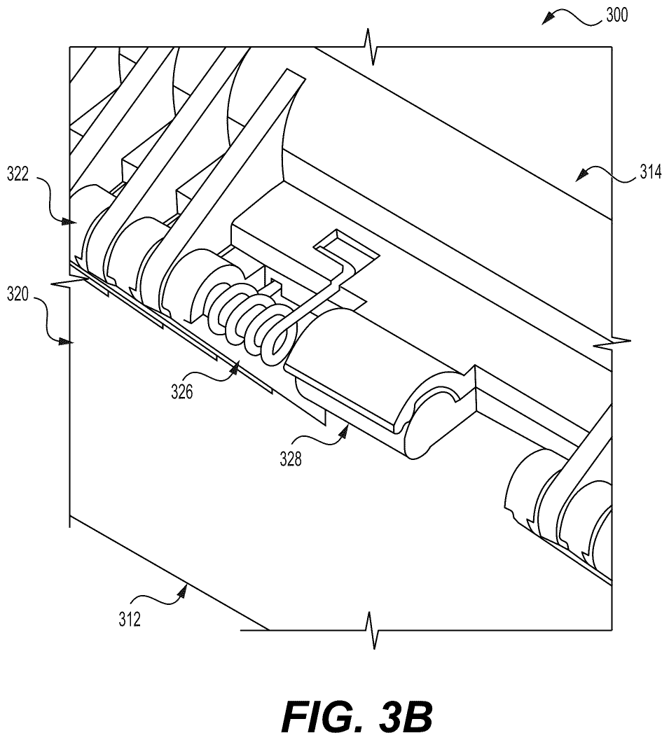

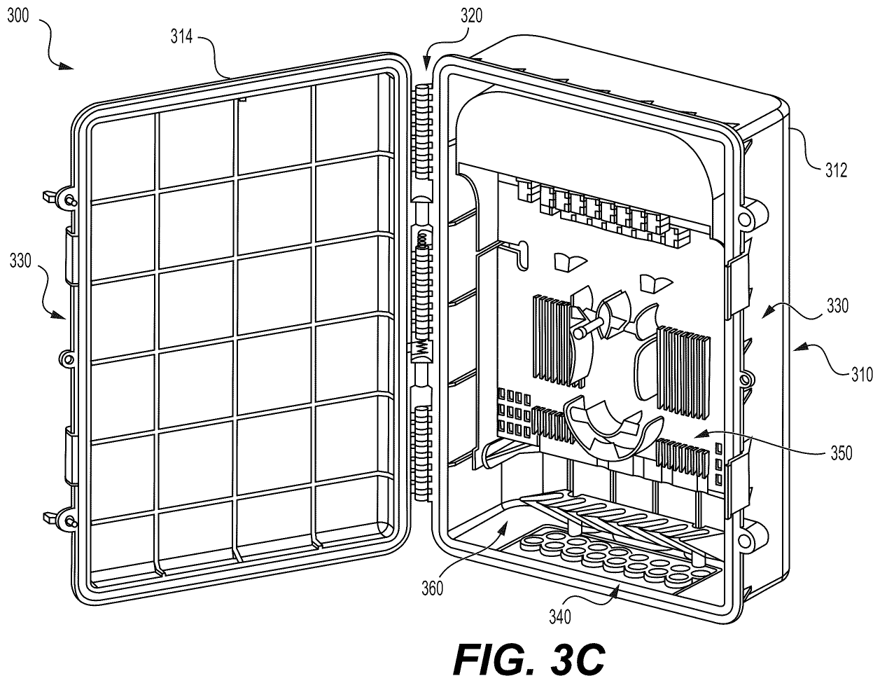

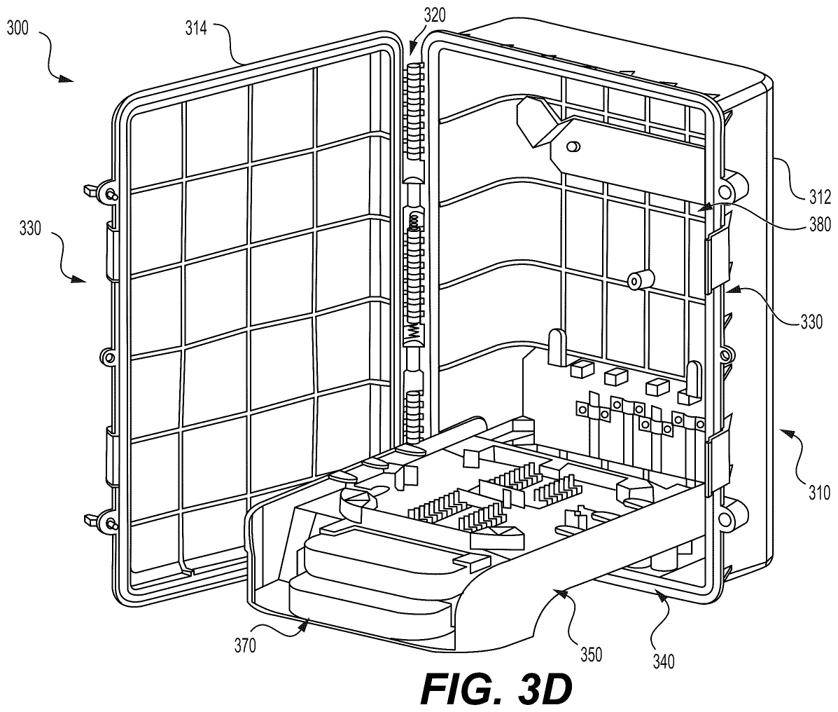

To address the inefficiencies of using multiple distribution boxes 410/420, or a single distribution box 130 with inefficient complexity and access, various embodiments provide a distribution box with relatively small physical size that provide efficient cable management, interconnections 120, and access. FIGS. 3A-3D illustrate perspective views of portions of an exemplary compact distribution box 300 that can be employed in the cable environment 100 of FIG. 1 in accordance with assorted embodiments. The view shown in FIG. 3A conveys how the compact distribution box 300 closes to enclose one or more interconnections from an input cable into at least one output cables, as shown in FIG. 1.

The distribution box 300 has a sealed body 310 that has a bottom portion 312 mated to a top portion 314. While not required or limiting, the two body portions 312/314 may have one or more sealing members, such as a flange, seal, gasket, or nested ridge, that provides watertight protection for the internal cavity defined by the body portions 312/314. The body portions 312/314 are joined via a hinge 320 that has a passive portion 322 and an active portion 324. The passive portion 322 has the top body portion 314 rotating about an aspect of the bottom body portion 312 in response to force applied to the top body portion 314. The active portion 324 can have one or more biasing members, such as a spring, cam, and/or weight, that continuously applies force onto the top body portion 312 to allow for efficient opening and closing of the body 310 to protect an interior cavity.

Opposite the hinge 320, the body 310 has a closure 330 that can consist of any number, type, and position of closure features. In the non-limiting example of FIG. 3A, the closure 330 has a pair of engagement portions 332, for example latches, which operate to securely close the top body portion 312 to the bottom body portion 314. Although the closure 330 may have only engagement portions 332, various embodiments provide sealing portions 334, such as, for example, wingnut fasteners, to mate the top body portion 314 to the bottom body portion 312 in a water tight configuration, which can be aided by the sealing features of the body 310, such as a seal, gasket, ring, or nested ridge.

While the body 310 may be watertight with the aid of the hinge 320 and closure 330, portions of the body 310 can be available for access by one or more input cables, such as cable 110 of FIG. 1, via a port portion 340. It is contemplated that one or more of the port portions 340 are sealed ports 342 configured with a material, such as rubber, polymer, or fabric, which maintains a watertight internal body 310 cavity despite penetration by one or more input cables.

FIG. 3B illustrates a closer perspective view of portions of the active portion 324 of the hinge 320, as configured and operated in accordance with various embodiments. The active portion 324 is positioned between passive portions 322 and comprises a biasing member 326 that cooperates with a stay portion 328 to provide efficient opening and closing of the top body portion 314 relative to the bottom body portion 312. That is, the biasing member 326 applies force (for example, consistent force) directed to close the top body portion 314 unless the stay portion is engaged by moving the top body portion 314 to a predetermined angular position, such as greater than ninety degrees open relative to the bottom body portion 312.

For example, the stay portion 328 of the active portion 324 can overcome the closure force applied by the biasing member 326 when the top body portion 314 is opened past a predetermined angular threshold to maintain the position of the top body portion 314 in an open configuration without a user holding the top portion 314 open or relying on gravity to hold the top portion 314 in an open position. In accordance with various embodiments, the stay portion 328 can maintain the top body portion 314 in a position to expose the entirety of the interior cavity defined by the bottom body portion 312 without physical retention by a user. That is, the stay portion 328 holds the top body portion 314 in place until a user applies enough force, along with the force of the biasing member 326, to overcome the physical retention provided by the stay portion 328, which triggers the top body portion 314 to automatically close and make contact with the sealing ridge that surrounds the bottom body portion 312.

It is noted that an “open” position can be characterized as beyond an angular threshold with respect to the bottom body portion 312 that allows hands-free access to the internal cavity defined by the bottom body portion 312. It is noted that the shape, size, and arrangement of the stay portion 328 is not limited to a particular configuration, but can be a keyed protrusion that rotates about a stationary pole and overcomes biasing force once rotated beyond a predetermined angular threshold, such as, for example, 90°, 135°, or 180° relative to the bottom body portion 312.

With the active portion 324 of the hinge 320 capable of holding the top body portion 314 open relative to the bottom body portion 312, the compact distribution box 300 can provide hands-free access to the interior of the bottom body portion 312. In addition, the hinge 320 configuration allows for a “one-touch” closure that involves relatively light external force to reliably close the body portions 312/314 and allow the engagement portions 332 and/or sealing portions 334 to be selected to fully seal the body 310 and create a watertight unit.

FIG. 3C illustrates a perspective view of the compact distribution box 300 with the top body portion 314 open to expose the interior cavity of the bottom body portion 312. The interior of bottom body portion 312 is configured, in accordance with various embodiments, with a tray portion such as, for example, a tray 350 that can provide connectivity capabilities that increase the efficiency of the overall distribution box 300 compared to a box 130 that does not employ an articulable tray 350, as shown in FIGS. 3C and 3D. The distribution box 300 configuration of FIG. 3C conveys how the tray portion 350 is positioned in a stored location while FIG. 3D conveys how the tray portion 350 rotates about a portion of the bottom body portion 312 to present additional connectivity options. In accordance with various embodiments, the tray portion 350 can be physically locked in the position shown in FIG. 3C with one or more locks, such as a tamper-proof screw, keyed mechanism, or magnet assembly. Securing the tray portion 350 in the position shown in FIG. 3C with, for example, a screw that is operated using an uncommon tool prevents, or provides a deterrent to, an unauthorized user to access the area behind the tray portion 350.

In the first side of the tray portion 350, as conveyed in FIG. 3C, shows how a number of cable arrestors 360 are positioned between the tray portion 350 and the input ports 340. The cable arrestors 360 can provide increased cable organization and physical support compared to configurations where cable(s) 110 do not contact structure proximal the input ports 340 within the interior cavity of the bottom body portion 312. In embodiments, the arrestors 360 are arranged to support 6 mm drop cables.

With the tray portion 350 rotated, as shown in FIG. 3D, a module portion 370 can be easily observed. The module portion 370 can comprise any number of module regions that can respectively receive and support a connector module 400, as discussed below. The rotated tray portion 350 further shows how the interior cavity of the bottom body portion 312 can have a spooling portion 380 that allows cable 110 to be organized and physically supported while engaging one or more interconnects 120 within the compact distribution box 300.

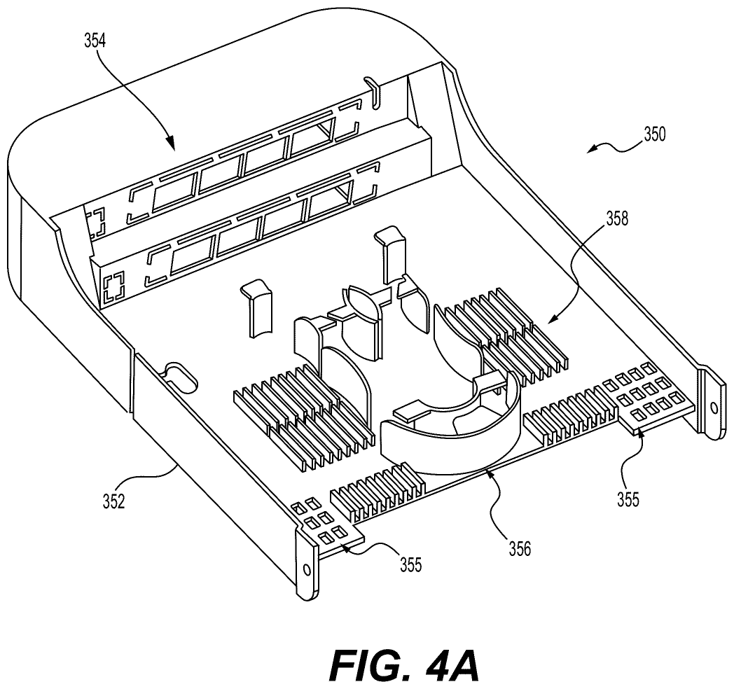

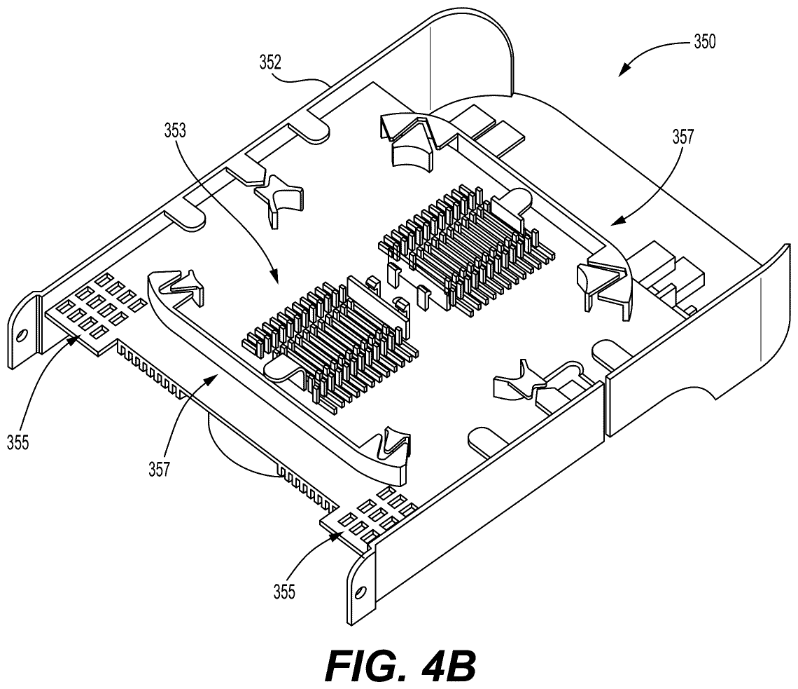

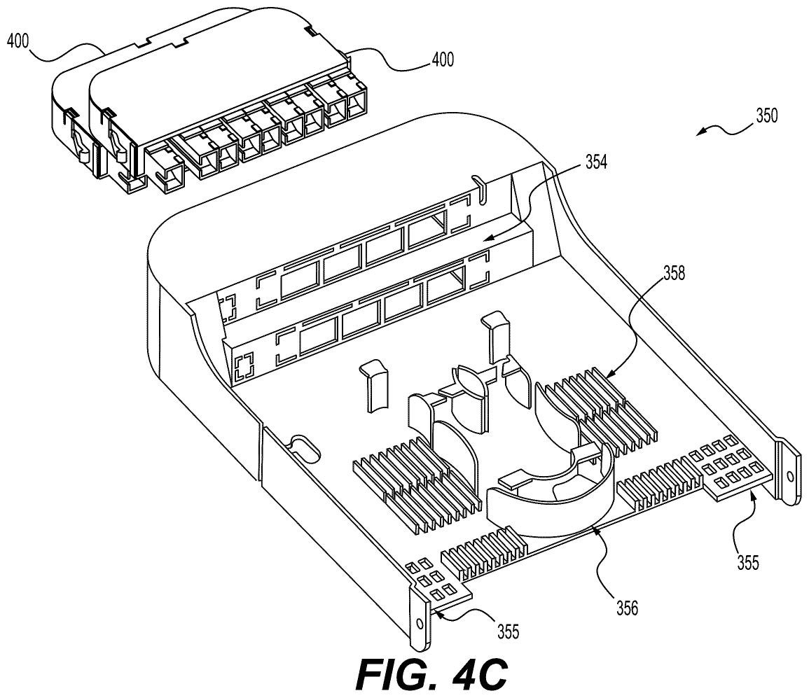

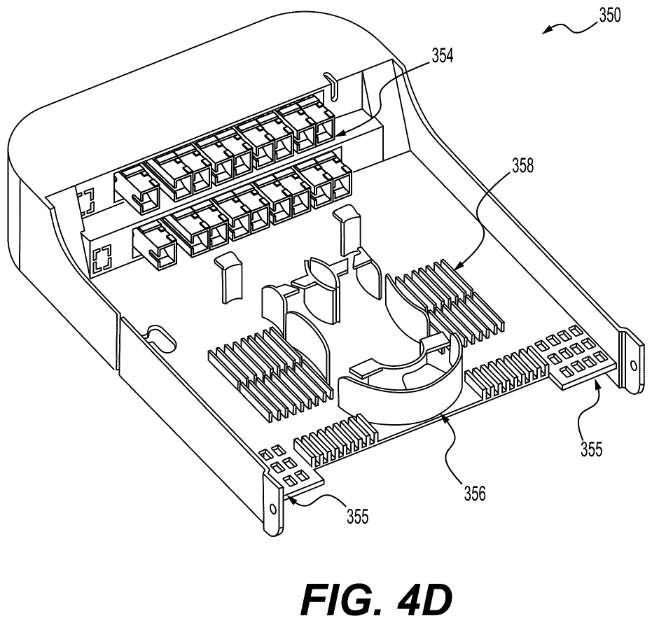

FIGS. 4A-4D respectively illustrate portions of the tray portion 350 of a compact distribution box 300 arranged in accordance with various embodiments. The tray portion 350 has a unitary body 352 that presents a knockout region 354 where connector modules 370 can engage and receive physical support. A spool portion 356 of the tray portion 350 provides efficient cable management while a splice region 358 provides a secure area to position spliced cable interconnections. Although not required, the tray portion 350 may comprise one or more cable tie regions 355 that allow cables to be physically secured in place on the tray body 352.

Various embodiments of the tray portion 350 provide flat cable arrestors on opposite sides for the spool portion 356, which further provides increased cable management and physical support efficiency, particularly as the tray portion 350 rotates relative to the bottom body portion 312, as illustrated in FIGS. 3C and 3D. Turning to the reverse side of the tray portion 350 displayed in FIG. 4B, splitter portions 353 are positioned between spool features 357 that allow cables to wrap around the tray portion 350 to increase cable management efficiency and relieve physical stress on the splice interconnections supported by the splitter portions 353.

FIGS. 4C and 4D illustrate how the tray portion 350 can engage connector modules 400 in accordance with some embodiments. FIG. 4C conveys how connector modules 400 are separate components that are oriented to physically extend through the knockout regions 354 of the tray body 352. It is noted that the tray body 352 can present any number of knockout regions 354 configured to physically support one or more connector modules 400 while allowing the modules 400 to be individually removed at will.

That is, the tray body 352 can comprise structure that physically supports one or more connector modules 400 while allowing a module 400 to be selected and removed from the tray body 352 without damage to the module 400 or tray body 352. Such configuration and capability can be characterized as modular construction where various different modules 400 can be inserted, utilized, and removed at will without damage.

In FIG. 4D, the modules 400 are inserted into a secure configuration in the knockout regions 354 of the tray body 352. Such configuration can securely provide cable interconnections, such as splitting, through the use of adapters, connectors, or interfaces, which can replace cable splicing. The staggered orientation of the respective modules 400, via the knockout regions 354, can provide efficient access and decreased installation times, but is not required or limiting as any knockout region 354 and module 400 configuration can be provided by a tray body 352.

The position of the knockout regions 354 can be strategically chosen relative to the spool portion 356 and splice region 358. That is, various embodiments position the spool portion 356 to efficiently allow access to, and from, the connectors of the respective modules 400 without creating cable management complexity or covering the available portions of the splice regions 358. In practice, the spool portion 356 allows efficient collection of signal conductors between the respective modules 400 and the splice interconnections located in the splice regions 358. As such, a technician can efficiently install, maintain, and alter the assorted interconnections provided by the modules 400 and splice regions 358.

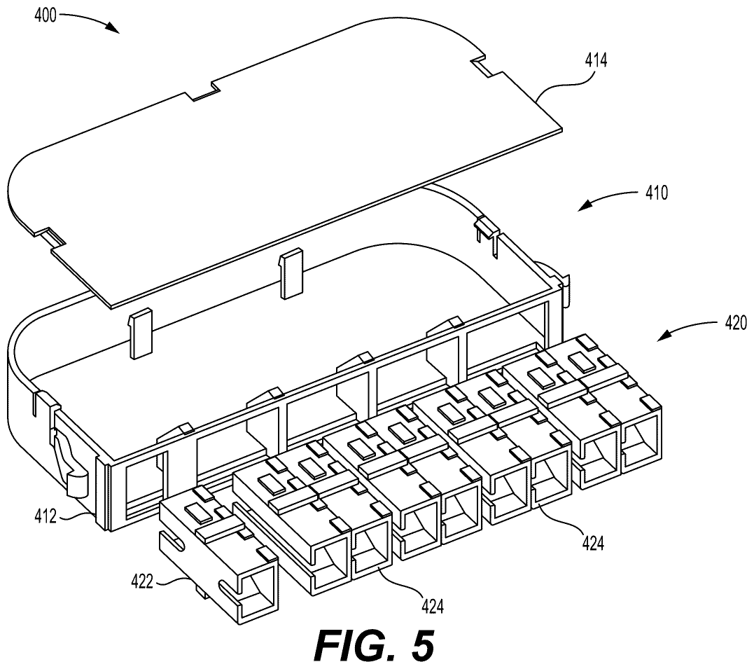

FIG. 5 illustrates a perspective view of an example exploded module 400 that can be employed in a compact distribution box 300 in various embodiments, such as the configuration shown in FIGS. 4A-4D. The module 400 has a body assembly 410 comprising a bottom portion 412 that securely mates with a top portion 414 to form a single unit that provides, for example, cable splitting. The body assembly 410 supports a group 420 of connectors, such as LC, SC, FC, ST, MPO, MTP, MDC, or HFOC connectors, which enable an input cable to be split into multiple output cables.

In the non-limiting arrangement shown in FIG. 5, a single input connector 422 can provide an input cable that is split in the interior cavity of the body assembly 410 into multiple output cables respectively supported by output connectors 424. In contrast to splicing or splitting a cable without connectors 422/424, the use of a module 400 allows for physically secure cable interconnections to be utilized. As a result, a user can pre-wire cable splitting arrangements with a module 400 and simply engage the respective connectors 422/424 once installed into the knockout region 354 of a tray body 352, which contrasts splicing or splitting cable only within a distribution box 130.

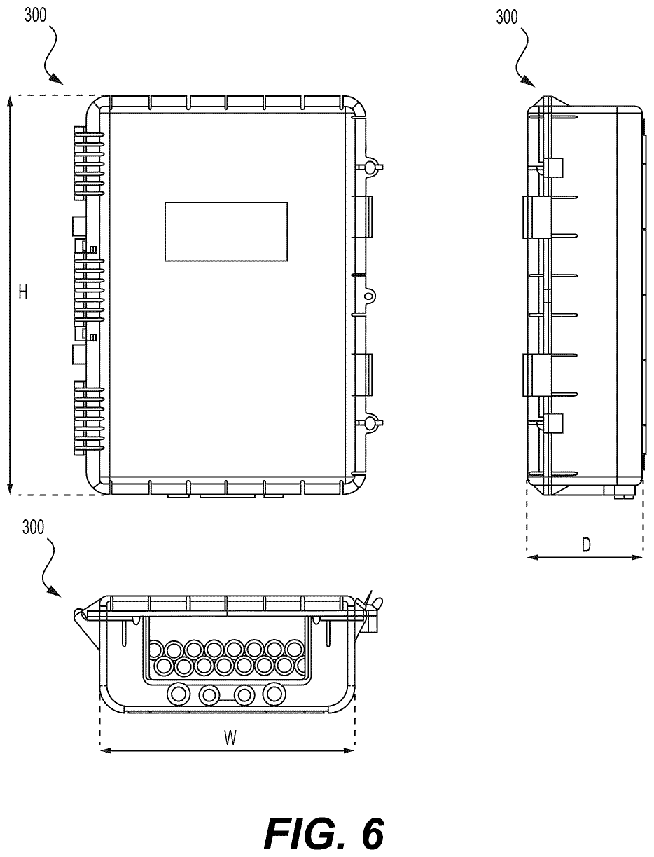

FIG. 6 illustrates assorted plan views of an example compact distribution box 300 configured in accordance with various embodiments. The front, side, and bottom plan views respectively shown in FIG. 6 convey how the distribution box 300 can be constructed with relatively small dimensions while still providing robust connectivity and efficient access over time. However, it is noted that none of the dimensions shown in FIG. 6 are limiting or required for assorted embodiments of a compact distribution box 300. The compact distribution box may, in some aspects, have a height H of about 315.0 mm, a width W of about 200.0 mm, and a depth of about 90.0 mm.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, a signal pathway conductor, an insulator, any shielding layers, and an outer jacket can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A cable distribution enclosure configured to provide enhanced connectivity and access to an interior of the enclosure, comprising
a first body portion having a port portion structurally configured to provide a sealed opening configured to receive a fiber optic cable passing through the port portion from an exterior of the first body portion to an interior of the first body portion;
a second body portion configured to cooperate with the first body portion to provide a watertight enclosure;
a hinge portion structurally configured to connect the second body portion with the first body portion;
a tray portion configured to be disposed in and pivotally coupled with the first body portion;
wherein the second body portion is configured to rotate relative to the first body portion about the hinge portion between a closed position in which the first body portion contacts the second body portion to form a watertight enclosure, and an open position in which the second body portion is rotated away from the first body portion to permit access to the tray portion;
wherein the hinge portion includes a biasing portion configured to urge the second body portion relative to the first body portion toward the closed position;
wherein the hinge portion includes a stay portion that is configured to overcome a biasing force applied to the second body portion by the biasing portion to maintain the second body portion in the open position relative to the first body portion when the second body portion is moved away from the first body portion to a defined angular orientation relative to the first body portion so as to permit a user to perform to access the tray portion in the cable distribution box without holding the second portion in the open position;
wherein the tray portion includes a first side portion facing the first body portion and a second side portion facing the second body portion;
wherein the tray portion includes a knockout portion configured to be removed from the tray portion to provide an access portion through the tray portion from the second side portion to the first side portion;
wherein the first side portion includes a holding portion configured to hold a fiber optic splitter and a first splice portion configured to retain fiber optic splice connections;
wherein the second side portion includes a second splice portion configured to retain fiber optic splice connections between optical fiber pigtails extending through the access portion from the first side portion and an optical fiber drop cable extending through the port portion of the first body portion;
wherein the first body portion is configured to receive a fiber optic splitter module such that an input port and output ports of the fiber optic splitter module extend through the access portion so as to permit connectors of preterminated fiber optic drop cables to be coupled with the input port and the outport ports; and
wherein the tray portion is structurally configured to permit a user to configure the enclosure with a fiber optic splitter module held by the first side portion and having the input port and the output ports extending through the access portion so as to permit preterminated fiber optic drop cables that extend through the port portion to an exterior of the enclosure to be coupled with the input port and the outport ports of the fiber optic splitter module without accessing the first side portion of the tray portion, and to alternatively configure the enclosure with fiber optic pigtails that extend from the first side portion through the access portion to the second splice portion so as to permit fiber optic drop cables that extend through the port portion to an exterior of the enclosure to be coupled with the fiber optic pigtails at the second splice portion without accessing the first side portion of the tray portion so as to enhance connectivity of the fiber optic enclosure.

2. The enclosure of claim 1, further comprising:
a fiber optic splitter module held by the first side portion and having the input port and the output ports extending through the access portion so as to permit preterminated fiber optic drop cables to be coupled with the input port and the outport ports of the fiber optic splitter module without accessing the first side portion of the tray portion.

3. The enclosure of claim 1, further comprising:
a fiber optic splitter configured to be held by the holding portion at the first side portion of the tray portion;
wherein the fiber optic splitter includes an input fiber and a plurality of output fibers, and wherein the plurality of output fibers are configured to extend from the first side portion, through the access portion, and to the second splice portion; and
wherein the plurality of output fibers from the fiber optic splitter are configured to be spliced with fiber optic drop cables that extend through the port portion to an exterior of the enclosure.

4. The enclosure of claim 1, further comprising:
an input optical fiber configured to extend from an exterior of the enclosure through the port portion, through the access portion, and to the first splice portion;
a pigtail optical fiber configured to be spliced with the input optical fiber at the first splice portion and to extend through the access portion to the second splice portion; and
wherein the pigtail optical fiber is configured to be spliced with a fiber optic drop cable that extends through the port portion to an exterior of the enclosure.

5. The enclosure of claim 1, wherein the tray portion is configured to be secured to the first body portion to prevent the tray portion from being moved away from the first body portion, thereby preventing access to the first side portion of the tray portion.

6. A cable distribution enclosure configured to provide enhanced connectivity and access to an interior of the enclosure, comprising:
a first body portion having a port portion structurally configured to receive a fiber optic cable passing through the port portion from an exterior of the first body portion to an interior of the first body portion;
a second body portion hingedly coupled with the first body portion;
a tray portion configured to be disposed in and pivotally coupled with the first body portion;
wherein the second body portion is configured to rotate relative to the first body portion between a closed position to form an enclosure and an open position in which the second body portion is rotated away from the first body portion to permit access to the tray portion;
wherein the tray portion includes a first side portion facing the first body portion and a second side portion facing the second body portion;
wherein the tray portion includes a knockout portion configured to be removed from the tray portion to provide an access portion through the tray portion from the second side portion to the first side portion;
wherein the first side portion includes a holding portion configured to hold a fiber optic splitter and a first splice portion configured to retain fiber optic splice connections;
wherein the second side portion includes a second splice portion configured to retain fiber optic splice connections between optical fiber pigtails extending through the access portion from the first side portion and an optical fiber drop cable extending through the port portion of the first body portion;
wherein the first body portion is configured to receive a fiber optic splitter module such that an input port and output ports of the fiber optic splitter module extend through the access portion so as to permit connectors of preterminated fiber optic drop cables to be coupled with the input port and the outport ports; and
wherein the tray portion is structurally configured to permit a user to configure the enclosure with a fiber optic splitter module held by the first side portion and having the input port and the output ports extending through the access portion so as to permit preterminated fiber optic drop cables that extend through the port portion to an exterior of the enclosure to be coupled with the input port and the outport ports of the fiber optic splitter module without accessing the first side portion of the tray portion, and to alternatively configure the enclosure with fiber optic pigtails that extend from the first side portion through the access portion to the second splice portion so as to permit fiber optic drop cables that extend through the port portion to an exterior of the enclosure to be coupled with the fiber optic pigtails at the second splice portion without accessing the first side portion of the tray portion so as to enhance connectivity of the fiber optic enclosure.

7. The enclosure of claim 6, further comprising:
a fiber optic splitter module held by the first side portion and having the input port and the output ports extending through the access portion so as to permit preterminated fiber optic drop cables to be coupled with the input port and the outport ports of the fiber optic splitter module without accessing the first side portion of the tray portion.

8. The enclosure of claim 6, further comprising:
a fiber optic splitter configured to be held by the holding portion at the first side portion of the tray portion;
wherein the fiber optic splitter includes an input fiber and a plurality of output fibers, and wherein the plurality of output fibers are configured to extend from the first side portion, through the access portion, and to the second splice portion; and
wherein the plurality of output fibers from the fiber optic splitter are configured to be spliced with fiber optic drop cables that extend through the port portion to an exterior of the enclosure.

9. The enclosure of claim 6, further comprising:
an input optical fiber configured to extend from an exterior of the enclosure through the port portion, through the access portion, and to the first splice portion;
a pigtail optical fiber configured to be spliced with the input optical fiber at the first splice portion and to extend through the access portion to the second splice portion; and
wherein the pigtail optical fiber is configured to be spliced with a fiber optic drop cable that extends through the port portion to an exterior of the enclosure.

10. The enclosure of claim 6, wherein the tray portion is configured to be secured to the first body portion to prevent the tray portion from being moved away from the first body portion, thereby preventing access to the first side portion of the tray portion.

11. The enclosure of claim 6, wherein the port portion is structurally configured to provide a sealed opening configured to receive a fiber optic cable passing through the port portion from an exterior of the first body portion to an interior of the first body portion.

12. The enclosure of claim 6, wherein the first body portion is configured to contact the second body portion in the closed position to form a watertight enclosure.

13. The enclosure of claim 6, further comprising a hinge portion configured to couple the first body portion with the second body portion;
wherein the hinge portion includes a biasing portion configured to urge the second body portion relative to the first body portion toward the closed position; and
wherein the hinge portion includes a stay portion that is configured to overcome a biasing force applied to the second body portion by the biasing portion to maintain the second body portion in the open position relative to the first body portion when the second body portion is moved away from the first body portion to a defined angular orientation relative to the first body portion so as to permit a user to perform to access the tray portion in the cable distribution box without holding the second portion in the open position.

14. A cable distribution enclosure configured to provide enhanced connectivity and access to an interior of the enclosure, comprising:
a body portion structurally configured to receive a fiber optic cable from an exterior of the body portion to an interior of the body portion;
a tray portion configured to be disposed in the body portion;
wherein the tray portion includes a first side portion facing the body portion and a second side portion facing away from the body portion;
wherein the tray portion is configured to provide an access portion through the tray portion from the second side portion to the first side portion;
wherein the first side portion includes a holding portion configured to hold a fiber optic splitter and a first splice portion configured to retain a fiber optic splice connections;
wherein the second side portion includes a second splice portion configured to retain fiber optic splice connections between an optical fiber pigtail extending through the access portion from the first side portion and an optical fiber drop cable extending through the port portion of the first body portion;
wherein the first body portion is configured to receive a fiber optic splitter module such that an input port and an output port of the fiber optic splitter module extend through the access portion so as to permit connectors of preterminated fiber optic drop cables to be coupled with the input port and the outport port; and
wherein the tray portion is structurally configured to provide enhanced connectivity by permitting a user to configure the enclosure with a fiber optic splitter module held by the first side portion and having the input port and the output port extending through the access portion so as to permit preterminated fiber optic drop cables that extend through the port portion to an exterior of the enclosure to be coupled with the input port and the outport port of the fiber optic splitter module without accessing the first side portion of the tray portion, and to alternatively configure the enclosure with an fiber optic pigtail that extends from the first side portion through the access portion to the second splice portion so as to permit a fiber optic drop cable that extends through the port portion to an exterior of the enclosure to be coupled with the fiber optic pigtail at the second splice portion without accessing the first side portion of the tray portion so as to enhance connectivity of the fiber optic enclosure.

15. The enclosure of claim 14, further comprising:
a fiber optic splitter module held by the first side portion and having the input port and the output ports extending through the access portion so as to permit preterminated fiber optic drop cables to be coupled with the input port and the outport ports of the fiber optic splitter module without accessing the first side portion of the tray portion.

16. The enclosure of claim 14, further comprising:
a fiber optic splitter configured to be held by the holding portion at the first side portion of the tray portion;
wherein the fiber optic splitter includes an input fiber and a plurality of output fibers, and wherein the plurality of output fibers are configured to extend from the first side portion, through the access portion, and to the second splice portion; and
wherein the plurality of output fibers from the fiber optic splitter are configured to be spliced with fiber optic drop cables that extend through the port portion to an exterior of the enclosure.

17. The enclosure of claim 14, further comprising:
an input optical fiber configured to extend from an exterior of the enclosure to an interior of the enclosure, through the access portion, and to the first splice portion;
a pigtail optical fiber configured to be spliced with the input optical fiber at the first splice portion and to extend through the access portion to the second splice portion; and
wherein the pigtail optical fiber is configured to be spliced with a fiber optic drop cable that extends through the port portion to an exterior of the enclosure.

18. The enclosure of claim 14, wherein the tray portion is configured to be secured to the body portion to prevent the tray portion from being moved away from the body portion, thereby preventing access to the first side portion of the tray portion.

19. The enclosure of claim 14, further comprising a port portion structurally configured to provide a sealed opening configured to receive a fiber optic cable passing through the port portion from the exterior of the first body portion to the interior of the first body portion.

20. The enclosure of claim 14, wherein the body portion comprises a first body portion hingedly coupled with a second body portion;
wherein the first body portion is configured to move relative to the second body portion between a closed position and an open position; and
wherein the first body portion is configured to contact the second body portion in the closed position to form a watertight enclosure.

21. The enclosure of claim 20, further comprising a hinge portion configured to couple the first body portion with the second body portion;
wherein the hinge portion includes a biasing portion configured to urge the second body portion relative to the first body portion toward the closed position; and
wherein the hinge portion includes a stay portion that is configured to overcome a biasing force applied to the second body portion by the biasing portion to maintain the second body portion in the open position relative to the first body portion when the second body portion is moved away from the first body portion to a defined angular orientation relative to the first body portion so as to permit a user to perform to access the tray portion in the cable distribution box without holding the second portion in the open position.

22. The enclosure of claim 14, wherein the tray portion includes a knockout portion configured to be removed from the tray portion to provide the access portion.
